(19) United States
(12) Patent Application Publication
(10) Pub. No.: US 2026/0049867 A1
(43) Pub. Date: Feb. 19, 2026

(54) GAS ABSORPTION SPECTROMETER, CONTROL PROGRAM, AND CONTROL METHOD

(71) Applicant: SHIMADZU CORPORATION, Kyoto-shi (JP)

(72) Inventor: Kazune MANO, Kyoto-shi (JP)

(21) Appl. No.: 19/297,093

(22) Filed: Aug. 12, 2025

(30) Foreign Application Priority Data
Aug. 13, 2024 (JP) 2024-134839

(51) Int. Cl. G01J 3/433; G01J 3/42; G01N 21/39

(52) U.S. Cl. CPC G01J 3/4338; G01N 21/39; G01J 2003/423

(57) ABSTRACT

A gas absorption spectrometer comprises a resonator for storing the sample, a light source for outputting laser light to the resonator, a modulator disposed in an optical path between the light source and the resonator for modulating a frequency of the laser light, a first photodetector for detecting light leaking from the resonator, a second photodetector for detecting light reflected by the resonator and returned to the light source side, a piezoelectric element for changing a cavity length of the resonator, and a controller. The controller, based on the light detected by the second photodetector, controls at least one of the modulator and the piezoelectric element to bring light in the resonator into a resonant state, and after changing the light in the resonator from the resonant state to a non-resonant state, measures a target component in the sample based on the light detected by the first photodetector.

### TECHNICAL FIELD

The present disclosure relates to a gas absorption spectrometer, a non-transitory computer readable medium, and a control method.

### BACKGROUND ART

As shown in Non-Patent Literature 1, Cavity Ring-Down Spectroscopy (CRDS) is known as a type of gas absorption spectroscopy. CRDS is a spectroscopic technique that sensitively determines the concentration of a target component in a gas within a resonator (cavity) by using the resonator to lengthen the effective optical path length.

In CRDS, laser light is input from a light source into a resonator. In the resonator, light is accumulated in a resonant state using the input laser light. After sufficient laser light has been accumulated in the resonator, the input of laser light to the resonator is shut off. Thereafter, the decay of the light leaking from the resonator is measured. The gas absorption spectrometer acquires the output signal of a photodetector as a “ring-down signal.”

The gas absorption spectrometer measures the concentration of a target component contained in the gas within the resonator by calculating the decay time constant of the light (ring-down time) using the acquired ring-down signal. In such a gas absorption spectrometer, it is desirable for the frequency of the laser light output from the light source to be constant in order to bring the light into a resonant state in the resonator. For this reason, in the gas absorption spectrometer, control to lock the laser light at a constant frequency may be performed using the Pound-Drever-Hall (PDH) method.

### PRIOR ART DOCUMENTS

### Non-Patent Literature

[Non-Patent Literature 1] Kazuto Mano, “Development of a Cavity Ring-down Spectrometer for Radiocarbon Isotopes (14C),” Shimadzu Review, Vol. 78, pp. 255-264 (2021)

[Non-Patent Literature 2] New Focus Application Note: Introduction to Laser Frequency Stabilization, https://www.newport-japan.JP/pdf/technical/1477.pdf

### SUMMARY OF INVENTION

### Problem to be Solved by the Invention

As a method for bringing light into a resonant state in a resonator, it is known to control the cavity length of the resonator using a piezoelectric element. The piezoelectric element is feedback-controlled based on the light reflected by the resonator and returned to the light source side. However, because the responsiveness of the piezoelectric element is not sufficient, depending on the frequency of the light detected from the resonator, the piezoelectric element could not be controlled with high precision, and there were cases where the resonator could not be properly brought into a resonant state.

The present disclosure has been made to solve the above-described problem, and an object thereof is to provide a technology capable of appropriately bringing a resonator into a resonant state.

### Means for Solving the Problem

A gas absorption spectrometer according to an aspect of the present disclosure is a gas absorption spectrometer that analyzes a sample. The gas absorption spectrometer comprises a resonator for storing the sample, a light source for outputting laser light to the resonator, a modulator disposed in an optical path between the light source and the resonator for modulating a frequency of the laser light, a first photodetector for detecting light leaking from the resonator, a second photodetector for detecting light reflected by the resonator and returned to the light source side, a piezoelectric element for changing a cavity length of the resonator, and a controller. The controller, based on the light detected by the second photodetector, controls at least one of the modulator and the piezoelectric element to bring light in the resonator into a resonant state, and after changing the light in the resonator from the resonant state to a non-resonant state, measures a target component in the sample based on the light detected by the first photodetector.

A non-transitory computer readable medium according to an aspect of the present disclosure is the non-transitory computer readable medium where a control program is stored, the control program being to be executed by a computer that is used in a gas absorption spectrometer that analyzes a sample. The gas absorption spectrometer comprises a resonator for storing the sample, a light source for outputting laser light to the resonator, a modulator disposed in an optical path between the light source and the resonator for modulating a frequency of the laser light, a first photodetector for detecting light leaking from the resonator, a second photodetector for detecting light reflected by the resonator and returned to the light source side, and a piezoelectric element for changing a cavity length of the resonator. The control program causes the computer to execute a step of, based on the light detected by the second photodetector, controlling at least one of the modulator and the piezoelectric element to bring light in the resonator into a resonant state, and a step of, after changing the light in the resonator from the resonant state to a non-resonant state, measuring a target component in the sample based on the light detected by the first photodetector.

A control method according to an aspect of the present disclosure is a control method used in a gas absorption spectrometer that analyzes a sample. The gas absorption spectrometer comprises a resonator for storing the sample, a light source for outputting laser light to the resonator, a modulator disposed in an optical path between the light source and the resonator for modulating a frequency of the laser light, a first photodetector for detecting light leaking from the resonator, a second photodetector for detecting light reflected by the resonator and returned to the light source side, and a piezoelectric element for changing a cavity length of the resonator. The control method includes, as processes caused to be executed by a computer, a step of, based on the light detected by the second photodetector, controlling at least one of the modulator and the piezoelectric element to bring light in the resonator into a resonant state, and a step of, after changing the light in the resonator from the resonant state to a non-resonant state, measuring a target component in the sample based on the light detected by the first photodetector.

### Advantageous Effects of Invention

According to the present disclosure, by performing appropriate feedback control according to the frequency of the laser light, the frequency of the laser light can be locked, and the resonant state of the laser light can be maintained.

### BRIEF DESCRIPTION OF DRAWINGS

FIG. 1 is a diagram schematically showing a configuration of a gas absorption spectrometer according to the present embodiment.

FIG. 2 is a conceptual diagram for explaining mode frequencies.

FIG. 3 is a functional block diagram of the gas absorption spectrometer in the present embodiment.

FIG. 4 is a flowchart showing a process for acquiring a ring-down signal in the present embodiment.

FIG. 5 is a functional block diagram of a gas absorption spectrometer in a comparative example.

### DESCRIPTION OF EMBODIMENTS

Hereinafter, the present embodiment will be described in detail with reference to the drawings. In the following description, identical or corresponding parts in the drawings are denoted by the same reference signs, and a description thereof will not be repeated.

### Configuration of Gas Absorption Spectrometer

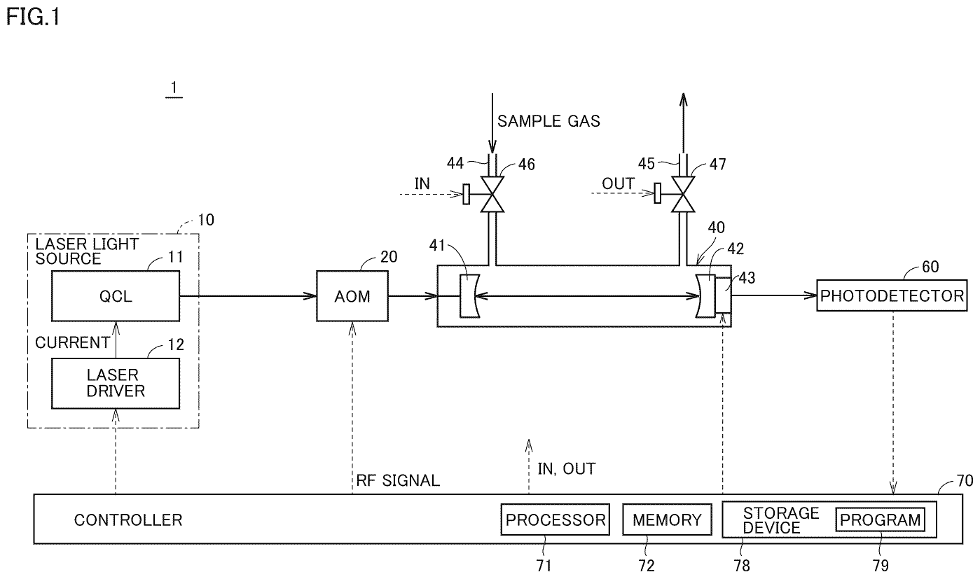

FIG. 1 is a diagram schematically showing a configuration of a gas absorption spectrometer 1 according to the present embodiment. The gas absorption spectrometer 1 comprises a laser light source 10, an AOM (Acousto-Optic Modulator) 20, a CRDS cavity 40, a photodetector (PD) 60, and a controller 70.

The laser light source 10 includes a measurement QCL (Quantum Cascade Laser) 11 and a laser driver 12. The measurement QCL 11 outputs laser light to the cavity 40. The measurement QCL 11 is configured to have a variable oscillation frequency of the laser light based on a current applied from the laser driver 12. Specifically, the measurement QCL 11 is a distributed feedback quantum cascade laser (QCL). The measurement QCL 11 is an example of the “light source”in the present disclosure.

The AOM 20 is provided in the optical path between the measurement QCL 11 and the CRDS cavity 40. The AOM 20 is an example of the “modulator” in the present disclosure. The AOM 20 is capable of switching at high speed between outputting and shutting off the laser light from the measurement QCL 11 to the CRDS cavity 40.

The AOM 20 enters an ON state in which it outputs the laser light from the measurement QCL 11 to the CRDS cavity 40 when an RF (Radio Frequency) signal having a predetermined frequency is applied from the controller 70. The AOM 20 enters an OFF state in which it does not output the laser light from the measurement QCL 11 to the CRDS cavity 40 when the application of the RF signal from the controller 70 is stopped.

The AOM 20 is configured to be able to modulate the frequency of the laser light. The AOM 20 changes the frequency of the laser light output from the AOM 20 to the CRDS cavity 40 according to the frequency of the RF signal. More specifically, the frequency of the laser light after being modulated by the AOM 20 becomes a value obtained by adding the frequency of the RF signal to the frequency of the laser light output from the measurement QCL 11.

The CRDS cavity 40 is provided in the optical path between the AOM 20 and the photodetector 60. The CRDS cavity 40 is an example of the “resonator” in the present disclosure. The CRDS cavity 40 is configured including a container (cell) capable of storing a sample gas, and has an inlet pipe 44 for introducing the sample gas into the interior before a measurement starts, and an outlet pipe 45 for discharging the sample gas to the exterior after the measurement ends. An inlet valve 46 is provided on the inlet pipe 44. An outlet valve 47 is provided on the outlet pipe 45. The controller 70 controls the opening and closing of the inlet valve 46 and the outlet valve 47.

Inside the CRDS cavity 40, a pair of mirrors 41, 42 is provided. The mirrors 41, 42 are arranged opposite each other such that light is reflected between them inside the CRDS cavity 40. For the mirrors 41, 42, a concave mirror may be adopted for at least one of the mirrors 41, 42 to facilitate satisfying the stability condition of the CRDS cavity 40. The other mirror may be planar or convex. Also, for the mirrors 41, 42, ones with high reflectivity (e.g., about 99.9%) are adopted so that the light leaking to the outside of the CRDS cavity 40 becomes extremely weak. The number of mirrors arranged inside the CRDS cavity 40 is not limited to two and may be three or more. That is, it may be a resonator in which mirrors are arranged to reflect light between each other, or it may be a resonator in which mirrors are arranged in a ring to reflect light in one direction.

A piezoelectric element 43 is disposed on the mirror 42. The piezoelectric element 43 drives the mirror 42 constituting the CRDS cavity 40 in accordance with a command from the controller 70, thereby displacing the mirror 42 in the optical axis direction. This changes the cavity length of the CRDS cavity 40. Note that the piezoelectric element 43 may be disposed on the mirror 41 instead of the mirror 42, or the piezoelectric element 43 may be disposed on both the mirror 41 and the mirror 42.

The photodetector 60 is, for example, a photodiode. The photodetector 60 detects weak light leaking from the mirror 42 of the CRDS cavity 40 as output light of the CRDS cavity 40 and outputs a detection signal to the controller 70. For the photodetector 60, for example, a liquid nitrogen-cooled InSb (indium antimonide) detector can be adopted. The photodetector 60 may correspond to the “first photodetector” in the present disclosure.

The controller 70 includes a processor 71 such as a CPU (Central Processing Unit) or FPGA (Field-Programmable Gate Array), a memory 72 such as a ROM (Read Only Memory) and a RAM (Random Access Memory), a storage device 78, and an input/output port (not shown).

The storage device 78 stores various programs executed by the processor 71, various data, and the like. The storage device 78 may be one or more non-transitory computer readable media or one or more computer readable storage media. Examples of the storage device 78 include flash memory, an HDD (Hard Disk Drive), and an SSD (Solid State Drive). The storage device 78 according to Embodiment 1 stores a control program 79. The control program 79 is a program for controlling the AOM 20 and the piezoelectric element 43, which will be described later, to control the laser light to a resonant state. The processor 71 loads the control program 79 into the memory 72 and executes it.

The controller 70 controls each device constituting the gas absorption spectrometer 1. Specifically, the controller 70 detects the laser light and performs feedback control on the AOM 20 and the piezoelectric element 43, as will be described later. Further, the controller 70 outputs a command to the inlet valve 46 for introducing the sample gas into the CRDS cavity 40, and outputs a command to the outlet valve 47 for discharging the sample gas to the outside of the CRDS cavity 40.

The controller 70 applies a voltage for displacing the mirror 42 to the piezoelectric element 43. The controller 70 executes various data processes. The various data processes include a process of calculating the concentration (absolute concentration) of a target component contained in the sample gas based on the detection signal from the photodetector 60.

The controller 70 may be divided into two or more units for each function. For example, the controller 70 may be divided into a unit that controls each device and a unit that executes various data processes.

### Measurement Principle by Cavity Ring-Down Spectroscopy (CRDS)

The measurement principle by the cavity ring-down absorption spectroscopy in the gas absorption spectrometer 1 will be described. Generally, when the frequency of light irradiated onto a resonator is a specific frequency, resonance occurs in the resonator. Hereinafter, the frequency of the laser light input to the CRDS cavity 40 will be referred to as “laser frequency,” and the frequency of light at which resonance can occur due to the CRDS cavity 40 will be referred to as “mode frequency.”

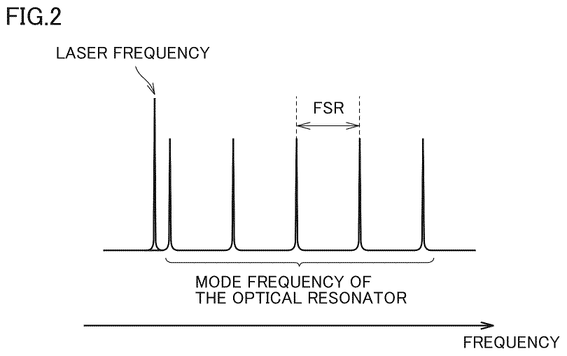

FIG. 2 is a conceptual diagram for explaining mode frequencies. As shown in FIG. 2, a plurality of mode frequencies exist at predetermined frequency intervals. Hereinafter, the interval between two adjacent mode frequencies among the plurality of mode frequencies will be referred to as “Free Spectral Range” (FSR).

When the laser frequency does not match any of the mode frequencies, the power of the light is not stored in the CRDS cavity 40. On the other hand, when the laser frequency matches any of the mode frequencies, the power of the light is stored in the CRDS cavity 40.

The controller 70 determines whether the power of the laser light has been sufficiently stored in the CRDS cavity 40 by the output signal of the photodetector 60. When the controller 70 determines that the power of the laser light has been sufficiently stored in the CRDS cavity 40, it controls the AOM 20 to shut off the output of the laser light to the CRDS cavity 40.

Then, the light stored in the CRDS cavity 40 travels back and forth between the mirror 41 and the mirror 42 a large number of times (typically, several thousand to tens of thousands of times). This light gradually decays as it travels back and forth between the mirrors 41, 42 due to losses from reflection leakage of the mirrors 41, 42 and absorption by the target component in the sample gas. Therefore, the output light of the CRDS cavity 40 leaking from the mirror 42 gradually decays. In CRDS, by using the CRDS cavity 40 to lengthen the distance the light passes through the sample gas (effective optical path length), the light absorption can be detected even if the light absorption by the target component is extremely slight.

The controller 70 acquires a signal detected by the photodetector 60 while the light input to the CRDS cavity 40 is being shut off as a “ring-down signal.” The controller 70 calculates the decay time constant of the acquired ring-down signal as a “ring-down time.” The controller 70 calculates the concentration of the target component contained in the sample gas from the calculated ring-down time.

### Functional Block Diagram of Overall Configuration

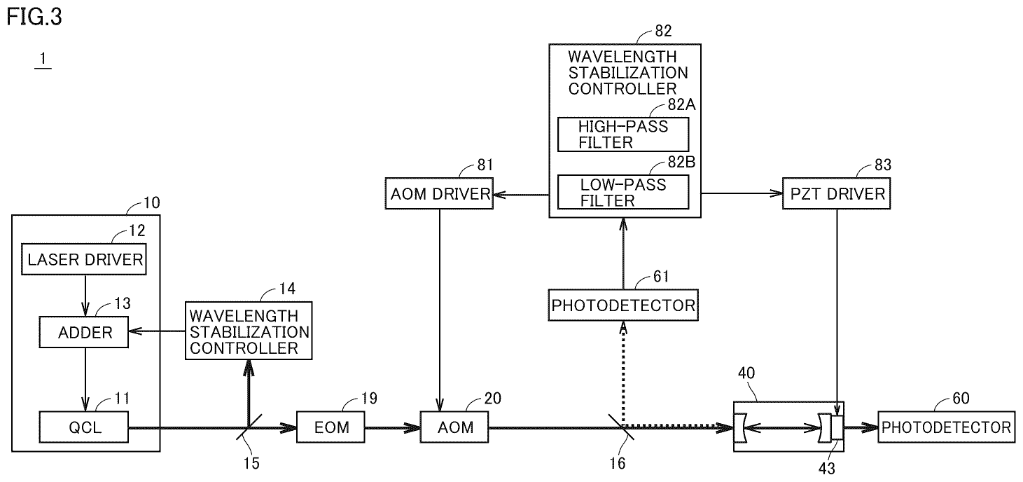

FIG. 3 is a functional block diagram of the gas absorption spectrometer 1 in the present embodiment. As shown in FIG. 3, a polarizing beam splitter (PBS) 15 and an EOM (Electro-Optic Modulator) 19 are disposed between the measurement QCL 11 and the AOM 20. The laser light output from the measurement QCL 11 is split by the polarizing beam splitter 15 into a direction toward the EOM 19 and the AOM 20 and a direction toward a wavelength stabilization controller 14.

The wavelength stabilization controller 14 stabilizes the frequency of the laser light using the Pound-Drever-Hall (PDH) method. The PDH method is a technique for stabilizing the frequency of laser light using an optical cavity. In the PDH method, laser light that has been phase-modulated by an electro-optic modulator is made incident on the optical cavity. In the PDH method, by using the obtained beat signal as an error signal for feedback control, the frequency of the laser light can be stabilized at a frequency where the carrier resonates with the optical cavity.

The wavelength stabilization controller 14 detects the laser light output from the measurement QCL 11 and transmits a signal to an adder 13 based on the detected laser light. The adder 13 adjusts the frequency of the laser light output from the measurement QCL 11 using the signal received from the wavelength stabilization controller 14. Thereby, the frequency of the laser light output from the measurement QCL 11 is kept at a desired frequency.

The EOM 19 modulates the phase of the laser light. The EOM 19 can electrically change the refractive index of light. The EOM 19 modulates the frequency and phase of the laser light based on a modulation signal input from an RF oscillator (not shown).

In the present embodiment, in order to maintain the laser light in a resonant state, at least one of the AOM 20 and the piezoelectric element 43 is controlled. As shown in FIG. 3, a beam splitter 16 is disposed between the AOM 20 and the CRDS cavity 40. The beam splitter 16 reflects the light that is reflected by the CRDS cavity 40 and returned to the AOM 30 side.

A photodetector 61 outputs an electrical signal corresponding to the intensity of the laser light. A wavelength stabilization controller 82 stabilizes the frequency of the laser light of the laser in the same manner as the wavelength stabilization controller 14, using the PDH method. The photodetector 61 is, for example, a photodiode, detects the light reflected by the beam splitter 16, and outputs a detection signal to the wavelength stabilization controller 82.

When the light reflected from the CRDS cavity 40 is extracted by the polarizing beam splitter 16 and received by the photodetector 61, a beat signal between the carrier and the sidebands is obtained. The obtained beat signal is used as an error signal for feedback control. In the present embodiment, at least one of the AOM 20 and the piezoelectric element 43 is a target of feedback from the wavelength stabilization controller 82.

The wavelength stabilization controller 82 has an RF oscillator that outputs a modulation signal (not shown). The RF oscillator generates a modulation signal for modulating the frequency or phase of the laser light. Furthermore, the wavelength stabilization controller 82 has a comparator that calculates an error as a comparison value of the difference between the resonance frequency of the CRDS cavity 40 and the frequency of the laser light from the detection signal of the photodetector 61 and the modulation signal of the RF oscillator.

In the present embodiment, in the wavelength stabilization controller 82, the comparison value is passed through a high-pass filter 82A and a low-pass filter 82B, whereby an error signal based on the error is generated. The wavelength stabilization controller 82 transmits a control signal for controlling an AOM driver 81 and a PZT driver 83 based on the error signal.

The wavelength stabilization controller 82 transmits a control signal corresponding to a frequency equal to or higher than a specific frequency filtered by the high-pass filter 82A to the AOM driver 81. The wavelength stabilization controller 82 transmits a control signal corresponding to a frequency lower than the specific frequency filtered by the low-pass filter 82B to the PZT driver 83.

The AOM driver 81 feedback-controls the AOM 20 using the control signal generated based on the comparison value that has passed through the high-pass filter 82A. Specifically, the AOM driver 81 controls the frequency of the RF signal input to the AOM 20 so that the frequency of the laser light output from the AOM 20 becomes the resonance frequency of the CRDS cavity 40.

The PZT driver 83 feedback-controls the piezoelectric element 43 using the control signal generated based on the comparison value that has passed through the low-pass filter 82B. Specifically, the PZT driver 83 controls the displacement of the piezoelectric element 43 so that the cavity length of the CRDS cavity 40 matches the frequency of the laser light.

In the present embodiment, the specific frequency is the upper limit value of the frequency band in which the piezoelectric element 43 can operate. In this way, the gas absorption spectrometer 1 of the present embodiment uses the AOM 20 to perform feedback control for input of laser light having a frequency equal to or higher than the upper limit value of the frequency band in which the piezoelectric element 43 can operate. On the other hand, the gas absorption spectrometer 1 uses the piezoelectric element 43 to perform feedback control for laser light having a frequency lower than the upper limit value of the frequency band in which the piezoelectric element 43 can operate. An example of the operable frequency range of the piezoelectric element 43 is 0 to several kHz, and an example of the operable frequency range of the AOM 20 is 0 to several hundred kHz. In this case, the specific frequency can be, for example, several kHz, which is the upper limit of the operable frequency range of the piezoelectric element 43.

When the frequency of the detected laser light is high, the responsiveness of the piezoelectric element 43 may become slow. In the present embodiment, when the frequency of the laser light detected by the photodetector 61 is equal to or higher than the specific frequency, feedback control is performed using the AOM 20. When the frequency of the detected laser light is high, the responsiveness of the AOM 20 is faster than the responsiveness of the piezoelectric element 43, so the gas absorption spectrometer 1 of the present embodiment can further stabilize the frequency of the laser light. This makes it possible for the gas absorption spectrometer 1 of the present embodiment to appropriately bring the laser light and the CRDS cavity 40 into a resonant state. In the present embodiment, the controller 70 described with reference to FIG. 1 includes at least one of the wavelength stabilization controller 82, the photodetector 61, the AOM driver 81, and the PZT driver 83. That is, the feedback control is executed by the controller 70.

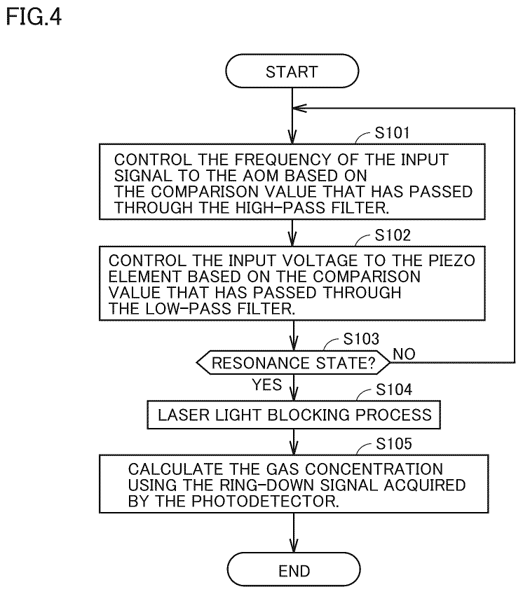

FIG. 4 is a flowchart showing a process for acquiring a ring-down signal in the present embodiment. The flowchart shown in FIG. 4 is realized by the processor 71 executing the control program 79. The processor 71 executes the control program 79 based on the detection of laser light by the photodetector 61.

The processor 71 controls the frequency of the RF signal input to the AOM 20 based on the comparison value that has passed through the high-pass filter 82A (Step S101). The processor 71 controls the displacement amount of the piezoelectric element 43 based on the comparison value that has passed through the low-pass filter 82B (Step S102). Through Steps S101 and S102, feedback control is executed to reduce the error by adjusting the frequency of the laser light in the laser light source 10 to the cavity length of the CRDS cavity 40.

The processor 71 determines whether the frequency of the laser light is in a resonant state with the resonance frequency of the CRDS cavity 40 based on the detection signal of the photodetector 60 (Step S103). That is, in Step S103, it is determined whether the power of the laser light in the CRDS cavity 40 is in a state of being sufficiently stored. If it is not in a resonant state (NO in Step S103), the processor 71 repeats the processes of Steps S101 and S102.

When it enters the resonant state (YES in Step S103), the processor 71 executes a shut-off process to shut off the laser light (Step S104). The shut-off process is executed, for example, by stopping the input of the RF signal to the AOM 20. Alternatively, the shut-off process may be executed by changing the frequency of the RF signal to the AOM 20.

After the output of the laser light to the CRDS cavity 40 is shut off, the processor 71 calculates the concentration of the target component contained in the sample gas using the ring-down signal acquired by the photodetector 60 (Step S105).

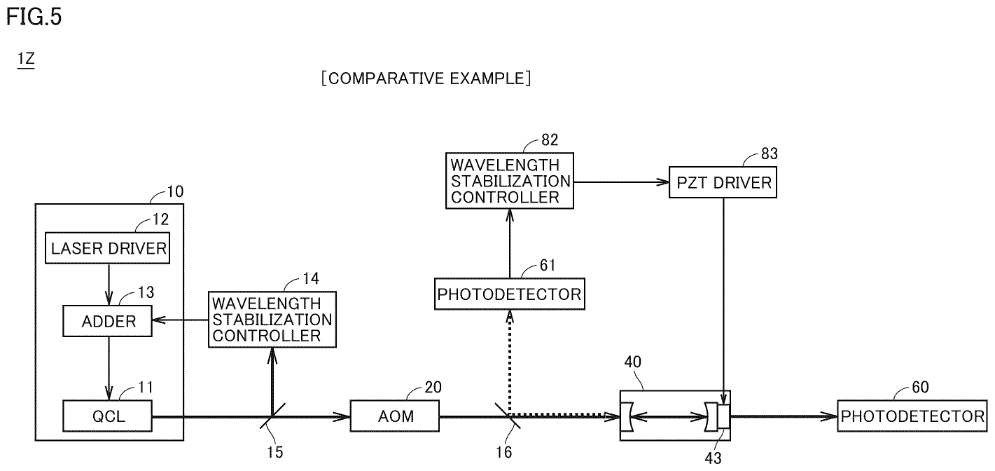

Hereinafter, a comparative example will be described. FIG. 5 is a functional block diagram of a gas absorption spectrometer 1Z in a comparative example. As shown in FIG. 5, in the gas absorption spectrometer 1Z of the comparative example, only the piezoelectric element 43 is a target of feedback from the wavelength stabilization controller 82. That is, in the gas absorption spectrometer 1Z of the comparative example, the AOM 20 is not a target of feedback from the wavelength stabilization controller 82.

In the comparative example, feedback control using the piezoelectric element 43 is performed regardless of the value of the frequency of the laser light detected by the photodetector 61, so the control by the PDH method may not be stable. On the other hand, in the present embodiment, when the frequency of the laser light detected by the photodetector 61 is equal to or higher than the specific frequency, feedback control is performed using the AOM 20. The gas absorption spectrometer 1 of the present embodiment can further stabilize the frequency of the laser light than the gas absorption spectrometer 1Z of the comparative example. That is, the gas absorption spectrometer 1 of the present embodiment can appropriately bring the laser light and the CRDS cavity 40 into a resonant state.

### Variations

In the gas absorption spectrometer 1 of Embodiment 1, an example has been described in which the processor 71 has an arithmetic processing unit such as a CPU. However, the processor 71 may be configured according to a hardware circuit dedicated to the gas absorption spectrometer 1. Also, in the example of FIG. 1, a configuration with a single processor is illustrated, but the gas absorption spectrometer 1 may have a plurality of processors.

The processor 71 is a processing entity (computer) that executes various processes according to various programs. The processor 71 can be configured by at least one of a CPU, an MPU, and a GPU (Graphics Processing Unit), for example. The processor 71 has the function of executing various processes by executing programs, but a part or all of these functions may be an application-specific integrated circuit such as an ASIC (Application Specific Integrated Circuit). The processor 71 may be configured by a processing circuitry.

In the present disclosure, the term “processor” is not limited to a processor in a narrow sense that executes processing in a stored program manner, such as a CPU or MPU, but may include hardwired circuits such as an ASIC or FPGA. For this reason, the processor 71 can also be read as a processing circuitry, in which processing is predefined by computer-readable code and/or hardwired circuits.

The processor 71 may be configured with a single chip or with multiple chips. Furthermore, the processor 71 and related processing circuits may be configured with multiple computers interconnected by wire or wirelessly via a local area network or a wireless network, etc. The processor 71 and related processing circuits may be configured with a cloud computer that performs computations remotely based on input data and outputs the computation results to other devices at a remote location.

Furthermore, in the above-described example, it was explained that the storage device 78 is an HDD, SSD, or the like. However, the storage device 78 may be of any format that can be read by the processor 71, which is a type of computer, and can non-transitorily record programs. For example, the storage device 78 may be any of a CD-ROM (Compact Disc-Read Only Memory), a DVD-ROM (Digital Versatile Disk-Read Only Memory), a USB (Universal Serial Bus) memory, a memory card, an FD (Flexible Disk), a hard disk, a magnetic tape, a cassette tape, an MO (Magnetic Optical Disc), an MD (Mini Disc), an IC (Integrated Circuit) card (excluding memory cards), an optical card, a mask ROM, or an EPROM.

Also, in the above-described example, it was explained that when the frequency of the laser light detected by the photodetector 61 is equal to or higher than a specific frequency, the AOM 20 becomes the target of feedback control. However, when the frequency of the laser light detected by the photodetector 61 is equal to or higher than the specific frequency, the QCL 11 may be the target of feedback control. More specifically, the target of the feedback control may be a modulator that directly modulates the frequency of the QCL 11. The modulator may, for example, control the frequency of the QCL 11 using a PLL (Phase Locked Loop) lock, and the wavelength stabilization controller 82 may perform feedback control by changing the target frequency of the modulator.

In the above-described example, an example was explained in which the wavelength stabilization controller 82 includes the high-pass filter 82A and the low-pass filter 82B. However, in some aspects, the wavelength stabilization controller 82 may have two filters, a first low-pass filter and a second low-pass filter, that pass frequencies below different frequencies. The first low-pass filter passes frequencies equal to or lower than the upper limit value of the operable frequency range of the AOM 20 and is used for feedback control of the AOM 20. The second low-pass filter passes frequencies equal to or lower than the upper limit value of the operable frequency range of the piezoelectric element 43 and is used for feedback control of the piezoelectric element 43. That is, in a low frequency region (a frequency band equal to or lower than the upper limit of the operable frequency range of the piezoelectric element 43), both the piezoelectric element 43 and the AOM 20 are targets of feedback control.

### Aspects

It is understood by those skilled in the art that the plurality of exemplary embodiments described above are specific examples of the following aspects.

(Item 1) A gas absorption spectrometer according to one aspect is a gas absorption spectrometer that analyzes a sample. The gas absorption spectrometer comprises a resonator for storing the sample, a light source for outputting laser light to the resonator, a modulator disposed in an optical path between the light source and the resonator for modulating a frequency of the laser light, a first photodetector for detecting light leaking from the resonator, a second photodetector for detecting light reflected by the resonator and returned to the light source side, a piezoelectric element for changing a cavity length of the resonator, and a controller. The controller, based on the light detected by the second photodetector, controls at least one of the modulator and the piezoelectric element to bring light in the resonator into a resonant state, and after changing the light in the resonator from the resonant state to a non-resonant state, measures a target component in the sample based on the light detected by the first photodetector.

According to the gas absorption spectrometer 1 described in Item 1, the resonator can be appropriately brought into a resonant state.

(Item 2) In the gas absorption spectrometer described in Item 1, the controller controls the modulator or the piezoelectric element according to a frequency of the light detected by the second photodetector.

According to the gas absorption spectrometer 1 described in Item 2, feedback control of the frequency is possible.

(Item 3) In the gas absorption spectrometer described in Item 2, the controller controls the modulator based on a first light including a frequency component of a specific frequency or higher among the light detected by the second photodetector, and controls the piezoelectric element based on a second light including a frequency component below the specific frequency.

According to the gas absorption spectrometer 1 described in Item 3, feedback control can be performed using the AOM in a frequency band where the responsiveness of the piezoelectric element is low.

(Item 4) The gas absorption spectrometer described in Item 3, further comprising at least one filter for separating a signal based on the light detected by the second photodetector into a signal based on the first light and a signal based on the second light.

According to the gas absorption spectrometer 1 described in Item 4, the laser light can be separated by frequency band.

(Item 5) In the gas absorption spectrometer described in Item 4, the at least one filter includes a high-pass filter for passing the signal based on the first light, and a low-pass filter for passing the signal based on the second light.

According to the gas absorption spectrometer 1 described in Item 5, separation according to the frequency band of the laser light can be performed using a high-pass filter and a low-pass filter.

(Item 6) The gas absorption spectrometer described in Item 4, comprising a first low-pass filter for passing the signal based on the first light, and a second low-pass filter for passing the signal based on the second light.

According to the gas absorption spectrometer 1 described in Item 6, feedback control according to the frequency band of the laser light is performed using two low-pass filters.

(Item 7) In the gas absorption spectrometer described in any one of Items 1 to 6, the modulator is an Acousto-Optic Modulator (AOM).

According to the gas absorption spectrometer 1 described in Item 7, feedback control can be performed using an acousto-optic modulator.

(Item 8) In the gas absorption spectrometer described in any one of Items 1 to 6, the modulator is a modulator that modulates a frequency of the laser light output from the light source.

According to the gas absorption spectrometer 1 described in Item 8, feedback control can be performed using an acousto-optic modulator.

(Item 9) A control program according to one aspect is a control program used in a gas absorption spectrometer that analyzes a sample. The gas absorption spectrometer comprises a resonator for storing the sample, a light source for outputting laser light to the resonator, a modulator disposed in an optical path between the light source and the resonator for modulating a frequency of the laser light, a first photodetector for detecting light leaking from the resonator, a second photodetector for detecting light reflected by the resonator and returned to the light source side, and a piezoelectric element for changing a cavity length of the resonator. The control program causes a computer to execute a step of, based on the light detected by the second photodetector, controlling at least one of the modulator and the piezoelectric element to bring light in the resonator into a resonant state, and a step of, after changing the light in the resonator from the resonant state to a non-resonant state, measuring a target component in the sample based on the light detected by the first photodetector.

According to the control program described in Item 9, the resonator can be appropriately brought into a resonant state.

(Item 10) A control method according to one aspect is a control method used in a gas absorption spectrometer that analyzes a sample. The gas absorption spectrometer comprises a resonator for storing the sample, a light source for outputting laser light to the resonator, a modulator disposed in an optical path between the light source and the resonator for modulating a frequency of the laser light, a first photodetector for detecting light leaking from the resonator, a second photodetector for detecting light reflected by the resonator and returned to the light source side, and a piezoelectric element for changing a cavity length of the resonator. The control method includes, as processes caused to be executed by a computer, a step of, based on the light detected by the second photodetector, controlling at least one of the modulator and the piezoelectric element to bring light in the resonator into a resonant state, and a step of, after changing the light in the resonator from the resonant state to a non-resonant state, measuring a target component in the sample based on the light detected by the first photodetector.

According to the control method described in Item 10, the resonator can be appropriately brought into a resonant state.

The embodiments disclosed herein should be considered in all respects as illustrative and not restrictive. To the extent they are not contradictory, at least two of the embodiments disclosed herein may be combined. The basic scope of the present disclosure is indicated not by the above description but by the scope of the claims, and it is intended that all changes within the meaning and scope equivalent to the scope of the claims are included.

### REFERENCE SIGNS LIST

1 Gas absorption spectrometer, 10 Laser light source, 11 Measurement QCL, 12 Laser driver, 13 Adder, 14, 82 Wavelength stabilization controller, 15, 16 Beam splitter, 40 CRDS cavity, 41, 42 Mirror, 43 Piezoelectric element, 44 Inlet pipe, 45 Outlet pipe, 46 Inlet valve, 47 Outlet valve, 60, 61 Photodetector, 70 Controller, 71 Processor, 72 Memory, 78 Storage device, 79 Control program, 81 AOM driver, 83 PZT driver, 82A High-pass filter, 82B Low-pass filter.

1. A gas absorption spectrometer for analyzing a sample, comprising:
a resonator for storing the sample;
a light source for outputting laser light to the resonator;
a modulator for modulating a frequency of the laser light;
a first photodetector for detecting light leaking from the resonator;
a second photodetector for detecting light reflected by the resonator and returned to the light source side;
a piezoelectric element for changing a cavity length of the resonator; and
a controller,
wherein the controller:
based on the light detected by the second photodetector, controls at least one of the modulator and the piezoelectric element to bring light in the resonator into a resonant state, and
after changing the light in the resonator from the resonant state to a non-resonant state, measures a target component in the sample based on the light detected by the first photodetector.

2. The gas absorption spectrometer according to claim 1, wherein the controller controls the modulator or the piezoelectric element according to a frequency of the light detected by the second photodetector.

3. The gas absorption spectrometer according to claim 2, wherein the controller:
controls the modulator based on a first light including a frequency component of a specific frequency or higher among the light detected by the second photodetector, and controls the piezoelectric element based on a second light including a frequency component below the specific frequency.

4. The gas absorption spectrometer according to claim 3, further comprising at least one filter for separating a signal based on the light detected by the second photodetector into a signal based on the first light and a signal based on the second light.

5. The gas absorption spectrometer according to claim 4, wherein the at least one filter includes a high-pass filter for passing the signal based on the first light, and a low-pass filter for passing the signal based on the second light.

6. The gas absorption spectrometer according to claim 4, wherein the at least one filter includes a first low-pass filter for passing the signal based on the first light, and a second low-pass filter for passing the signal based on the second light.

7. The gas absorption spectrometer according to any one of claim 1, wherein the modulator is an Acousto-Optic Modulator (AOM).

8. The gas absorption spectrometer according to any one of claim 1, wherein the modulator is a modulator that modulates a frequency of the laser light output from the light source.

9. A non-transitory computer readable medium where a control program is stored, the control program being to be executed by a computer that is for use in a gas absorption spectrometer that analyzes a sample,
the gas absorption spectrometer comprising:
a resonator for storing the sample;
a light source for outputting laser light to the resonator;
a modulator disposed in an optical path between the light source and the resonator for modulating a frequency of the laser light;
a first photodetector for detecting light leaking from the resonator;
a second photodetector for detecting light reflected by the resonator and returned to the light source side; and
a piezoelectric element for changing a cavity length of the resonator,
the control program causing the computer to execute:
a step of, based on the light detected by the second photodetector, controlling at least one of the modulator and the piezoelectric element to bring light in the resonator into a resonant state; and
a step of, after changing the light in the resonator from the resonant state to a non-resonant state, measuring a target component in the sample based on the light detected by the first photodetector.

10. A control method for use in a gas absorption spectrometer that analyzes a sample,
the gas absorption spectrometer comprising:
a resonator for storing the sample;
a light source for outputting laser light to the resonator;
a modulator disposed in an optical path between the light source and the resonator for modulating a frequency of the laser light;
a first photodetector for detecting light leaking from the resonator;
a second photodetector for detecting light reflected by the resonator and returned to the light source side; and
a piezoelectric element for changing a cavity length of the resonator,
the control method comprising, as a process caused to be executed by a computer:
a step of, based on the light detected by the second photodetector, controlling at least one of the modulator and the piezoelectric element to bring light in the resonator into a resonant state; and
a step of, after changing the light in the resonator from the resonant state to a non-resonant state, measuring a target component in the sample based on the light detected by the first photodetector.
